(19) United States
(12) Patent Application Publication
(10) Pub. No.: US 2006/0133080 A1
(43) Pub. Date: Jun. 22, 2006

(54) Multiple light source orientation system for multi-well reaction plate

(75) Inventors: Jeffrey A. Goldman, Acton, MA (US); Vladimir Krasheninin, Worcester, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., a corporation of the state of Delaware, Hercules, CA (US)

(21) Appl. No.: 11/016,024

(22) Filed: Dec. 17, 2004

(51) Int. Cl. F21V 21/00

(52) U.S. Cl. 362/249; 362/227; 362/234; 362/236

(57) ABSTRACT

Light-emitting diodes are mounted in a support block that holds the diodes in a fixed orientation. In certain embodiments, the orientation of the diodes by the support block causes the axes of the diodes to converge below the block to a common point where, in preferred embodiments, components of an excitation optical system are placed. The converging light then diverges for entry into an array of receptacles in which individual chemical reactions take place. The block contains engineered apertures that securely retain the diodes, each aperture including a shoulder for the flange at one end of each diode.

### BACKGROUND OF THE INVENTION

1. Field of the Invention

This invention lies in the field of illumination systems such as those used for machine vision or illumination or for biological or chemical assays in multiple reaction systems.

2. Description of the Prior Art

Advances in microbiology, and particularly in the study and use of nucleic acids for diagnostic, clinical, and research purposes, have led to the development of complex automated equipment in which large numbers of procedures are performed simultaneously. The typical procedure is a sequence of reaction steps, each performed at a specified temperature. The sequence is typically repeated, as many as 30-40 times, with thermal cycling and with detection of the progress of the reaction at each stage of a cycle. Among the procedures that have been performed in this manner are polymerase chain reactions, strand displacement amplifications, ligase chain reactions, self-sustained sequence replication, enzyme kinetic studies, and certain ligand binding assays. Monitoring of the reactions and control of the reaction conditions in each stage of the sequence is essential to the achievement of reliable and meaningful results.

A particularly effective means of reaction monitoring for these systems is the use of optical readers and scanners. Light sources described in the literature for use in these scanners range from incandescent bulbs and fluorescent tubes to xenon flash tubes, lasers, light-emitting diodes and x-ray tubes. Light-emitting diodes (LEDs) emitting either ultraviolet, infrared, or visible-range light offer durability, low power dissipation, and a rapid switching speed. These attributes, coupled with the small size of the typical LED, make these devices the light source of choice for many operations. A particularly convenient detection method is fluorescence, which offers a high degree of control and specificity plus ease of quantification. Means of detecting fluorescence are varied, and examples are photomultiplier tubes, CCD cameras, SMOS detectors, and photodiodes.

In typical procedures, a multitude of samples, up to several hundred in some cases, are processed simultaneously in individual reaction wells arranged in two-dimensional arrays such as microplates. The optimal system is therefore one that provides uniformity and reproducibility among each of the wells or reaction systems as well as a reliable means for monitoring the progress of the reactions in each well. The factors that tend to prevent these systems from performing at their optima are sensitivity of the detecting systems and crosstalk between signals from adjacent samples. In systems that utilize LEDs, these difficulties have been attributable in part to the LEDs themselves due to variances in the internal construction of the LEDs. To compensate for these variances, individual adjustments and normalizations of the LEDs are often made. Examples of methods that have been developed to make these adjustments are the use of curable adhesives as disclosed by Thrailkill, W., in U.S. Pat. No. 5,822,053 (issued Oct. 13, 1998), the use of a controller to adjust power levels to individual LEDs as disclosed by Goldman, J. A., et al., in U.S. Pat. No. 6,825,927 B1, issued Nov. 30, 2004, and the use of either silicon photodiodes with associated feedback circuitry or calibration phosphors, as disclosed by Lee, J. D., et al., in United States Pre-Grant Patent Publication No. US 2004/0222384 A1, published Nov. 11, 2004.

### Summary of the Invention

It has now been discovered that an array of reaction wells can be illuminated with excitation light from individual LEDs with a high level of accuracy and uniformity among the wells by the use of a specially engineered support block to serve as a holding plate for positioning the LEDs. The support block has an array of apertures extending through the block, each aperture having a longitudinal axis and contoured to receive a single LED in a fixed orientation along the axis. In certain embodiments of the invention, the axes are oriented to converge at a location between the LED support block and the reaction well array, preferably passing through a common point at the site of convergence. The light beams from the LEDs likewise converge at approximately the same point, and both the axes and the light beams diverge before reaching the multi-well array. A lens is preferably positioned between the convergence of the beams and the multi-well array to orient the light beam axes in a direction normal to the wells, thereby directing excitation light to each well from a direction approximately normal to the mouth of the well. In other embodiments, the apertures and hence the LEDs are oriented either to diverge or to be parallel. Features of the apertures and the support block and further objects, aspects, and advantages of the invention will be apparent from the description that follows.

### BRIEF DESCRIPTION OF THE DRAWINGS

FIG. 1 depicts a light-emitting diode such as may be used in the practice of the present invention.

FIG. 2 is a perspective view of a light source and orientation system in accordance with the present invention.

FIG. 3 is a side view of an LED holder plate that is one of the components of the system depicted in FIG. 2.

FIG. 4 is a top view of the light source and orientation system of FIG. 2.

FIG. 5 is a cross section taken along the line 5-5 of FIG. 4.

FIG. 6 is a side elevation of a multi-receptacle reaction system incorporating the illumination and orientation system of FIG. 2.

### DETAILED DESCRIPTION OF THE INVENTION AND PREFERRED EMBODIMENTS

While the present invention is susceptible to a wide range of configurations, a detailed review of one particular configuration that exemplifies the invention will provide an understanding of the function and operation of the invention as a whole. The figures hereto depict one such configuration and are explained below.

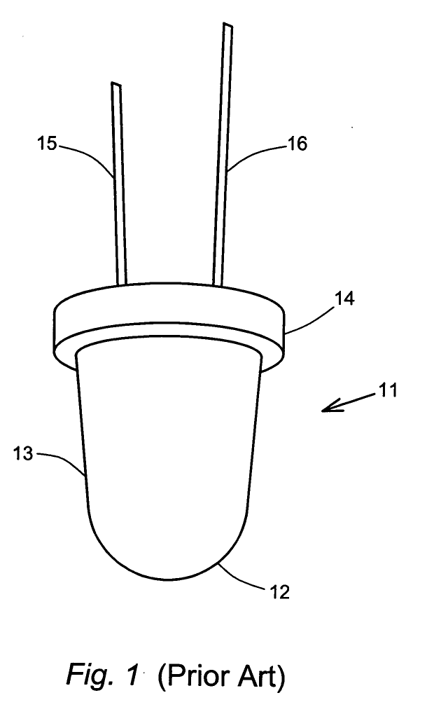

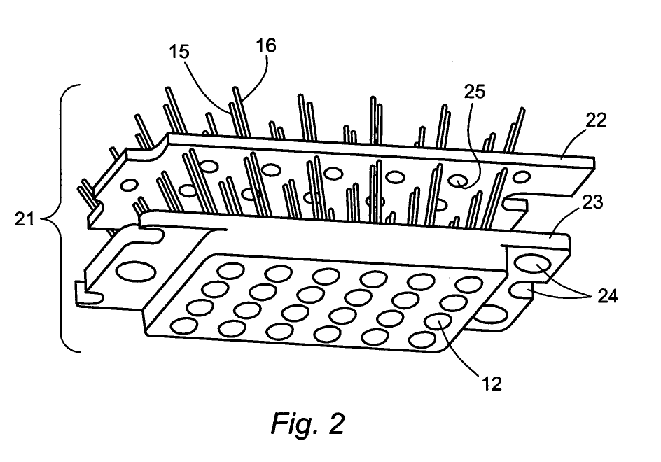

While LEDs can assume a variety of shapes and sizes, the exterior of a typical LED 11 for which the present invention is designed is shown in FIG. 1. Characteristic features of the shape of the exterior are a rounded (typically spherical) end 12, a slightly tapered body 13, a flange 14 opposite the rounded end, and a pair of electrical leads 15, 16. An example of an illumination system that incorporates an array of LEDs is shown in FIG. 2. The system 21 includes a printed circuit board 22, and LED holder plate 23, the LEDs themselves of which only the rounded ends 12 are visible, and the electric leads 15,16 joining the circuitry on the printed circuit board to the LEDs (the circuitry itself is not shown). A series of spacers (not shown) are positioned between the printed circuit board 22 and the LED holder plate 23, securing the board and plate together. Miscellaneous mounting holes 24 are included to permit securement of the system to an instrument. The holder plate holds an array of LEDs. The number is not critical to the present invention, and will be dictated by the instrument on which the illumination system is used and the sample plate in which the reactions are to be performed. Preferably, the array is a regularly spaced two-dimensional array. In this case, the array is a 4×6 rectangular array.

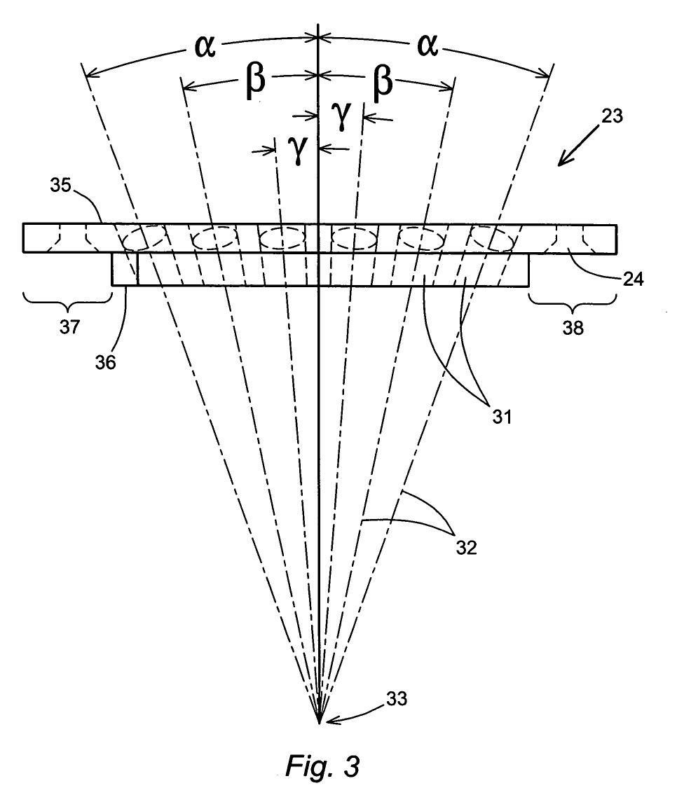

The side view of the LED holder plate in FIG. 3 depicts, in dashed lines, one row of LED apertures 31. Each aperture has a longitudinal axis 32 passing through its center, and when an LED resides in the aperture, the longitudinal axis 32 coincides with the axis of the LED. In this embodiment, the longitudinal axes 32 of the apertures are not parallel, but instead converge to a point 33 that is well below the underside of the LED holder plate 23, i.e., on the side from which the rounded ends of the LED themselves protrude. In other embodiments, not shown, the longitudinal axes 32 of the apertures may be parallel or may diverge.

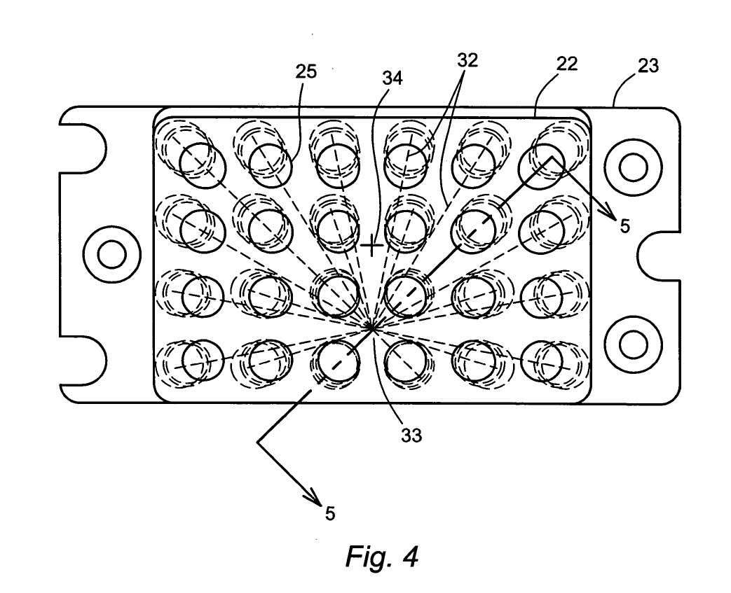

The orientation of the axes in the presented embodiment is further illustrated in FIG. 4 which is a top view of the printed circuit board 22 with the LED holder plate 23 underneath. This view shows that the longitudinal axes 32 of all 24 apertures converge to a common point 33 at a location spaced apart from and below the plate, and in this case, the point is offset from the central axis 34 of the LED holder plate itself.

Returning to FIG. 3, the holder plate 23 in the particular embodiment shown has an upper surface 35 and a lower surface 36 that are planar and parallel, and the plate contains mounting extensions 37, 38 at each end. The longitudinal axes of one row of apertures are shown in relation to an axis 34 that passes through the convergence point 33 and is normal to the upper and lower surfaces of the holder plate. The angles α, β, γof the longitudinal axes and hence the distance between the LEDs and the convergence point 33 will be selected to match the geometry of the system and the spatial arrangement of the components, and are otherwise not critical. In most cases, best results will be achieved with angles ranging from 0° to 30°, and preferably from 0° to 20°.

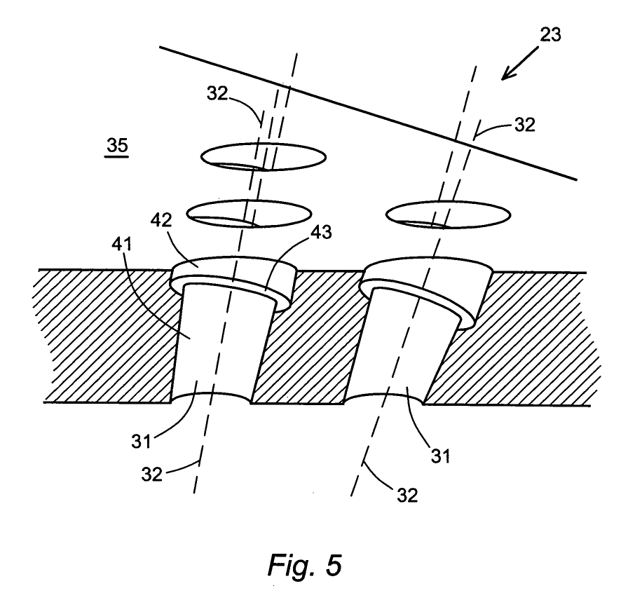

FIG. 5 is a cross section of the LED holder plate 23 taken along the plane indicated by the line 5-5 of FIG. 4. This cross section shows the interiors of two apertures 31, with the longitudinal axes visible. Since the LEDs shown in FIG. 1 are bodies of revolution about an axis, the apertures 31 are apertures of revolution, conforming to the contours of the LEDs. This however is not a requirement for proper functioning of the invention; any aperture configuration that will receive the LED and hold the LED in a fixed orientation with the LED axis aligned in the desired direction can be used. Circular cross-section apertures such as those shown are preferred for ease of manufacture and convenience. Each aperture has a lower section 41 and an upper section 42, the lower section being relatively lesser diameter than the upper, with a shoulder 43 connecting the two sections. The shoulder 43 serves as a stop for the flange 14 of the LED (FIG. 1), while the body 13 of the LED is accommodated by the lower section 41 in a snug fit. The plane of each shoulder 43 is normal to the longitudinal axis of the aperture. In preferred embodiments, the lower section 41 is slightly tapered to closely mate with an LED that is likewise tapered. (The taper is exaggerated in the figure for visibility, but in reality may be as little as 1.0°.)

To assemble the illumination system, i.e., to secure the LEDs in the LED holder plate fully connected with the circuitry in the printed circuit board, the following procedure can be used. The LEDs, which have been pre-sorted according to intensity, can first be attached to the printed circuit board by means of conventional spring contact pins, and the circuit board can then be attached to the LED holder plate through the spacers mentioned above, while the lower ends of the LEDs are lowered into the apertures in the holder plate. Thus lowered, the LEDs can be pressed into the apertures in a tight fit by a tool inserted through access holes 25 (FIGS. 2 and 4) in the printed circuit board.

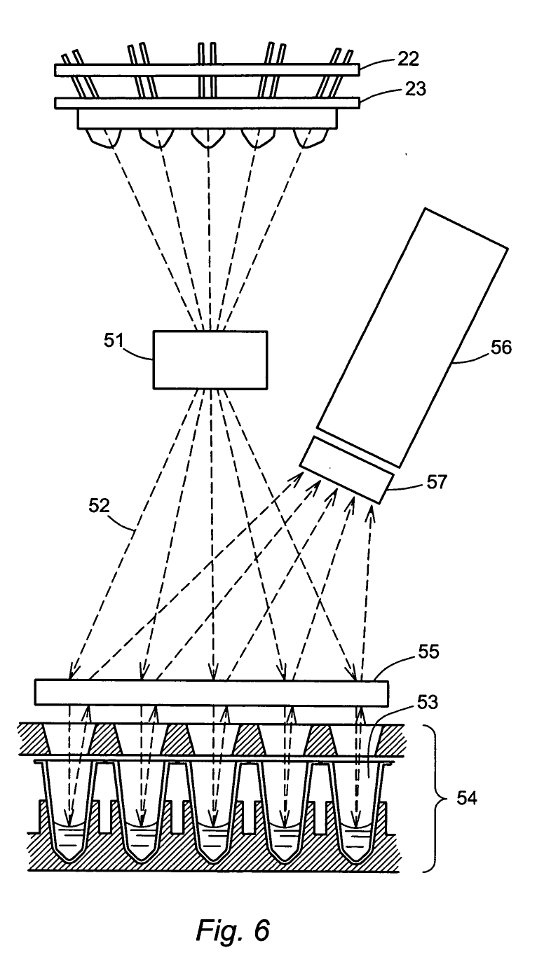

A side elevation of a multi-receptacle reaction system incorporating the illumination system of the preceding figures is shown in FIG. 6. A spectral interference filter 51 is shown in this particular system at a location coinciding with the convergence point of the light beams from the oriented LEDs. This filter limits the light to a particular wavelength that has been selected for excitation. After passing through the filter, the light beams diverge 52 toward each of the wells 53 in a multi-well plate 54. Prior to reaching the wells, the light beams pass through a field lens or lens system 55 that helps assure that the beams enter each of the wells and that the full amount of excitation light strikes the reaction medium within each well. In this case, the field lens re-directs the beams to be substantially parallel to each other and normal to the axes of the wells. A detection system is also shown, in the form of a detector such as a photomultiplier tube 56, the signals from which are processed by a signal processing system (not represented in this drawing). An emission lens system 57, filter system, or both can be placed in the optical path prior to the photomultiplier tube for control of the optical signal entering the photomultiplier tube.

The foregoing is offered for purposes of illustration. The principles of this invention are similarly applicable to uses other than directing excitation light to planar arrays of reaction wells, such as machine vision or illumination. It will be apparent to those skilled in the art that further modifications and substitutions can be made without departing from the spirit and scope of the invention.

What is claimed is:

1. A support block for a plurality of light-emitting diodes, each diode having a longitudinal diode axis and an external flange transverse to said diode axis, said support block comprising a plate with a plurality of apertures, each said aperture having a longitudinal aperture axis and contoured to receive a light-emitting diode in a fixed orientation with said diode axis aligned with said aperture axis.

2. The support block of claim 1 wherein said apertures have internal surfaces that are complementary in contour to external surfaces of said light-emitting diodes.

3. The support block of claim 1 wherein said apertures are sized to receive said light-emitting diodes in a friction fit.

4. The support block of claim 1 wherein each said aperture further has an internal shoulder to mate with said flange.

5. The support block of claim 1 wherein said apertures are oriented to converge at a location spaced apart from said support block.

6. The support block of claim 1 wherein said longitudinal aperture axes form angles with an axis normal to said support block, said angles ranging from 0° to 30°.

7. The support block of claim 1 wherein said support block has parallel upper and lower surfaces, and said longitudinal aperture axes form angles with an axis normal to said upper and lower surfaces, said angles ranging from 0° to 20°.

8. The support block of claim 1 wherein said plurality of apertures form a regularly spaced two-dimensional array.

9. Apparatus for supplying excitation light to a two-dimensional array of receptacles, said system comprising:
a support block having a plurality of apertures, each said aperture having a longitudinal aperture axis and contoured to receive a light-emitting diode in a fixed orientation along said longitudinal aperture axis, said apertures oriented such that said longitudinal aperture axes converge at a focal point at a location spaced apart from said support block, and
a lens positioned to direct diverging light from said focal point to each receptacle of said two-dimensional array.

10. The apparatus of claim 9 wherein said lens renders light from each of said light-emitting diodes substantially parallel.

11. The apparatus of claim 9 wherein said apertures have internal surfaces that are complementary in contour to external surfaces of said light-emitting diodes.

12. The apparatus of claim 9 wherein said apertures are sized to receive said light-emitting diodes in a friction fit.

13. The apparatus of claim 9 wherein said longitudinal aperture axes form angles with an axis normal to said support block, said angles ranging from 0° to 30°.

14. The apparatus of claim 9 wherein said longitudinal aperture axes form angles with an axis normal to said support block, said angles ranging from 0° to 20°.

15. The apparatus of claim 9 further comprising a shoulder within each of said apertures to receive a flange on each light-emitting diode.

16. The apparatus of claim 9 wherein said plurality of apertures form a regularly spaced two-dimensional array.
